(19) United States
(12) Patent Application Publication
(10) Pub. No.: US 2008/0154921 A1
(43) Pub. Date: Jun. 26, 2008

(54) FILE SYSTEM REPRESENTATION FOR ACCELERATED NAVIGATION

(75) Inventors: Frederic Bauchot, Saint-Jeannet (FR); Gerard Marmigere, Drap (FR); Joaquin Picon, St. Laurent du Var (FR)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 11/853,402

(22) Filed: Sep. 11, 2007

(30) Foreign Application Priority Data
Dec. 20, 2006 (FR) 06301270.2

(51) Int. Cl. G06F 17/30

(52) U.S. Cl. 707/100; 707/E17.044

(57) ABSTRACT

A file system representation, comprising a set of nodes, each node comprising attributes to indicate whether it is a frozen node or whether there is a frozen node below it, said file system representation being adapted to provide direct access to frozen nodes.

### FIELD OF THE INVENTION

The present invention relates to a computer file system structure, and more particularly to a structure that provides quick access to defined objects.

### BACKGROUND OF THE INVENTION

Computers are used to store, process and retrieve information. This information is organized in a file system to make it easy to find and access it. File systems may use a storage device such as a hard disk or CD-ROM and involve maintaining the physical location of the files. More formally, a file system is a set of abstract data types that are implemented for the storage, hierarchical organization, manipulation, navigation, access, and retrieval of data.

Different file system implementations exist for each operating system. For instance, the Second Extended File System (EXT2) is a UNIX-like file system for Linux. Microsoft Windows operating system supports the File Allocation Table (FAT) file system and the New Technology File System (NTFS).

Each file system must provide a way to identify and access uniquely each object that it manages. Directories—or folders—are objects that are used to create and hold access paths to the objects in the file system. Each object in a computer can then be uniquely represented by a combination of their name and their path. For instance, in UNIX-like file systems, ‘/home/user1/mybookmarks’ identifies the object named ‘mybookmarks’ (which can be a directory or a file), with its path ‘/home/user1/’. The path is made of directories, here ‘home’ and ‘user1’. Unix file systems all have a root directory (the first slash ‘/’) that is at the beginning of any object path. On the contrary, Microsoft Windows file systems use a driver letter abstraction to distinguish between different disks or partitions. Thus, ‘C:\Windows\system32\example.dll’ identifies the object ‘example.dll’ to be in drive ‘C:’, at the path ‘\Windows\system32’.

Operating systems also provide users with a tool, called a file system explorer, to browse the file system in order to locate an object, and to perform basic actions on this object such as ‘execute’, when the object is an executable, ‘open with program XYZ’ to make such program read the content of the object, ‘remove’ to delete the object, ‘copy’ to duplicate it, ‘move to . . . ’ to change the path of an object, etc.

As the complexity of the file system increases, it becomes difficult for users to quickly locate objects in the filesystem. Plus, even though users tend to access some objects more frequently than others, it is also cumbersome for these users to remember the exact path of each favorite object, as their number can grow in the thousands. File system explorers provide bookmarks or shortcuts mechanisms. Such bookmarks can also be organized and regrouped by themes, or interest, to make them more manageable as their number increase. The typical behaviour of such bookmarking mechanisms is to place the file system explorer at a given position in the file system, thus alleviating the tedious activity of browsing the file structure to locate a particular object.

Another problem is when a user needs to drag & drop to move or copy an object at a given path to another path in the filesystem, it is often the case that the target path doesn't appear in the display area. The user must then scroll to the target path while making the drag & drop action.

From a more general perspective, efficient display of a large file system structure by file system explorers is a common concern that many have tried to solve. For example, U.S. Pat. No. 6,654,761 discloses a method for controlling which part of data defining a node-link structure is in memory. Thus, when the file system explorer fetches information about the file system to display it to the user, the patent proposes a method to fetch and display first the subset of the file system structure that is more likely to be accessed by the user while navigating the file system.

### SUMMARY OF THE INVENTION

According to a first aspect of the present invention there is provided a method of representing file system objects by means of respective nodes in a hierarchical structure, wherein said file system objects are each associated with a first characteristic set to either a first or a second value, said method comprising the step of compiling said structure to represent objects hierarchically inferior to a first object by incorporating only nodes representing:
in response to a first navigation signal, all objects which are children of said first object and whose first characteristic has said second value, or which are parents of an object associated with said second value; and
in response to a second navigation signal, all objects which are either:
   first generation children of said first object, or
   children of said first generation children, whose first characteristic has said second value or who are parents of an object associated with said second value.

One advantage of this aspect is that it allows direct access to defined objects buried into the file system hierarchy, while taking into account the client navigation.

In a first development of the first aspect, the method comprises the further steps of:
designating one of said file system objects; and
setting, in response to said designation, the first characteristic associated with said designated object to said second value.

An advantage is that it provides flexibility in execution of the method.

In a second development of the first aspect, the first characteristic used in the method is permanently stored.

An advantage is that manipulations performed by the client to access the file structure faster can be reused the next time the method is executed.

In a third development of the first aspect, the file system objects are each associated with a second characteristic set to either a third or a fourth value, the method comprising the further steps of:
identifying, in response to said designation, objects which are parents of said second object; and
setting the second characteristic associated with each object so identified to said fourth value, in response to said designation.

An advantage is that detection of buried objects is faster.

In a fourth development of the first aspect, the second characteristic is permanently stored.

An advantage is that manipulations performed by the client to access the file structure can be reused faster the next time the method is executed.

In a fifth development of the first aspect, the method further comprises the steps of:
receiving a further one of said navigation signals on a chosen object, wherein said chosen object is one of said objects associated with said second value; and
repeating, in response to said further navigation signal, the compiling step of claim 1, with said chosen object replacing said first object.

An advantage is that the client can still browse the objects below a designated object, even though a parent object is collapsed.

In a sixth development of the first aspect, the first navigation signal is a collapse signal.

In a seventh development of the first aspect, the second navigation signal is an expand signal.

An advantage is that the client can still rely on the same navigation signals as in a standard file system explorer. No or very little changes are required on the client side to benefit from the invention.

According to a second aspect of the present invention, there is provided an apparatus comprising means adapted for carrying out each step of the method according to the first aspect of the invention.

An advantage is that this apparatus can be obtained very easily, thus making the method easy to execute.

According to a third aspect of the present invention, there is provided a computer-like readable medium comprising instructions for carrying out each step of the method according to the first aspect of the invention.

An advantage is that this medium can be used to easily install the method on various apparatus.

Further advantages of the present invention will become clear to the skilled person upon examination of the drawings and detailed description. It is intended that any additional advantages be incorporated herein.

### BRIEF DESCRIPTION OF THE DRAWINGS

Embodiments of the present invention will now be described by way of example with reference to the accompanying drawings in which like references denote similar elements, and in which:

FIG. 1 shows a system implementing the present invention;

FIG. 2 shows a list of relevant attributes for a node in an implementation of the present invention;

FIG. 3 shows a graphical representation of a node structure;

FIG. 4 shows a node structure in which two nodes have been frozen in an implementation of the present invention;

FIG. 5 shows a collapsed node structure in an implementation of the present invention;

FIG. 6 shows a node structure with some nodes collapsed and a node expanded, in an implementation of the present invention;

FIG. 7 shows a method for altering the node structure when a freeze event is detected, in an implementation of the present invention;

FIG. 8 shows a method for altering the node structure when an unfreeze event is detected, in an implementation of the present invention;

FIG. 9 shows a method for altering the node structure when a collapse event on a node is detected, in an implementation of the present invention; and

FIG. 10 shows a method for altering the node structure when an expand event on a node is detected, in an implementation of the present invention.

### DETAILED DESCRIPTION OF THE PREFERRED EMBODIMENT

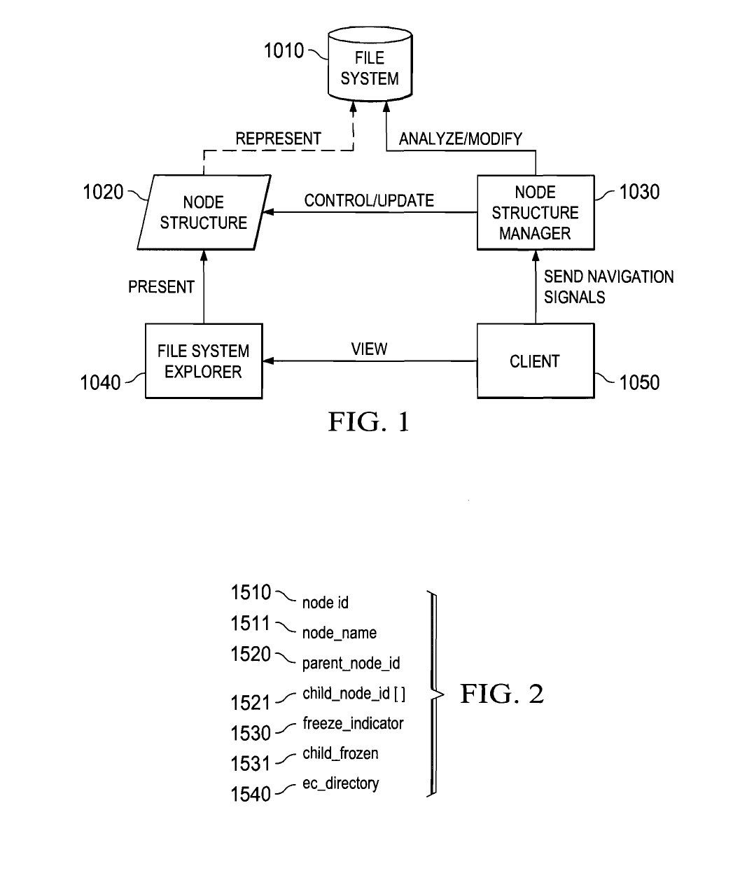

FIG. 1 shows a system implementing the present invention according to a first embodiment, such system comprising:
a file system (1010), used to store and organize the computer data, in the form of objects that can be files or folders, wherein these objects are commonly organized in a hierarchical manner, with for instance object A parent of objects B and C, and objects B and C children of object A;
a hierarchical node structure (1020), which can be a tree of nodes, and each node having a parent node and zero, one or several child nodes, and with one root node with no parents;
a node structure manager (1030), which is a computer process used to control the node structure (1020) and read, write on the file system (1010);
a file system explorer (1040), that provides an interface to view, browse the file system, and more precisely the node structure (1020); and
a client (1050), which can be a user or a computer process, that interacts with the file system (1010) through the node structure manager (1030) and based on information provided by the file system explorer (1040).

The node structure (1020) is a representation of the file system (1010) that is built by the node structure manager (1030). Such representation contains a subset of all the objects available on the file system (1010). Its goal is to provide an advanced mechanism for navigating and interacting with the file system (1010), as simply or as fast as possible.

Having this goal of producing an optimized node structure (1020) representing efficiently the file system and the states of its objects, the node structure manager (1030) also acts on the file system to optimize the organization of the data and be able to interact the relevant information as fast as possible.

The file system explorer (1040), which is in fact a node structure explorer, takes as input the node structure (1020), presents it and provides the client (1050) with functionality to browse the data as represented in the node structure.

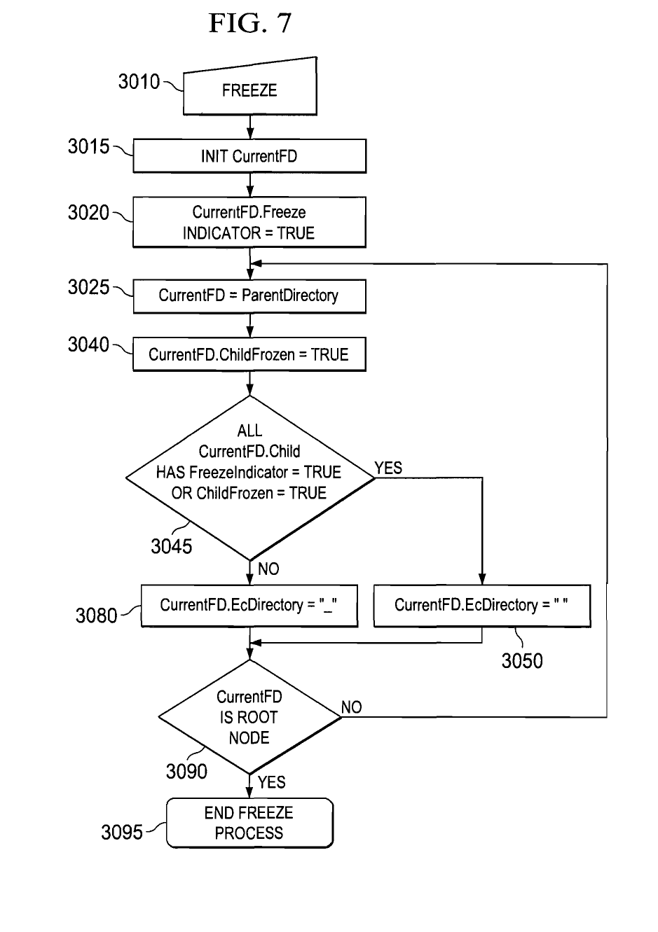

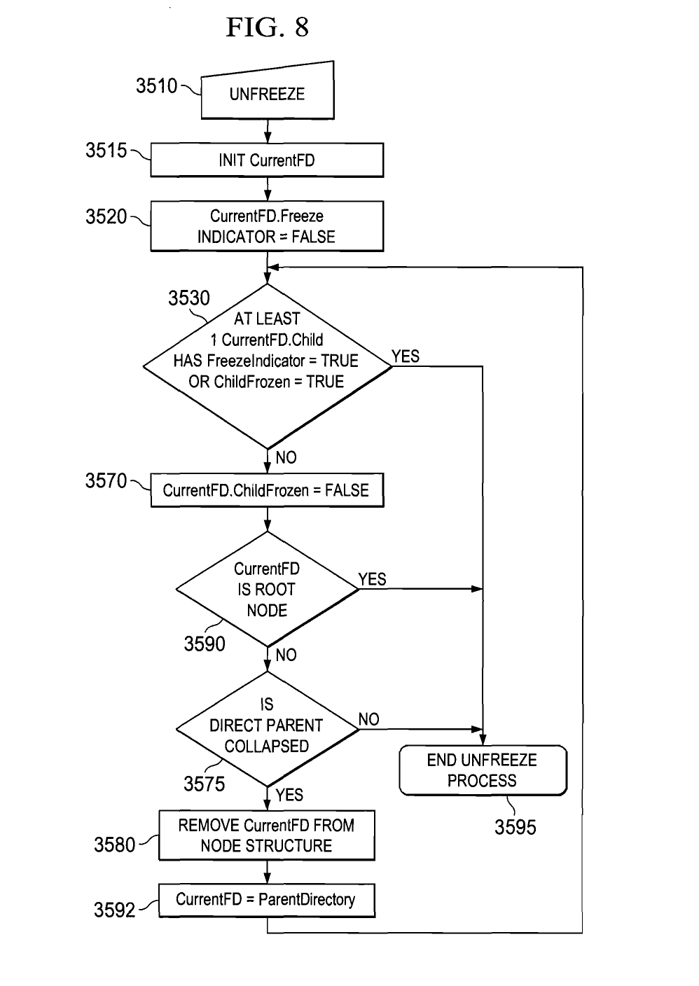

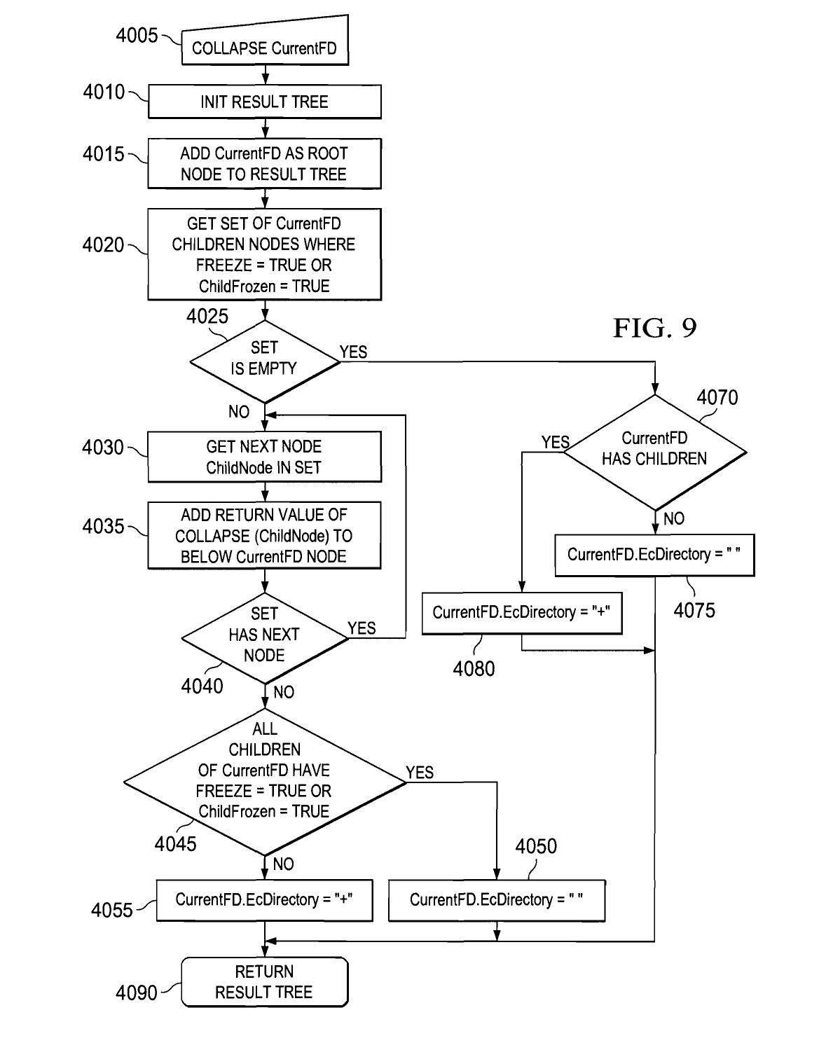

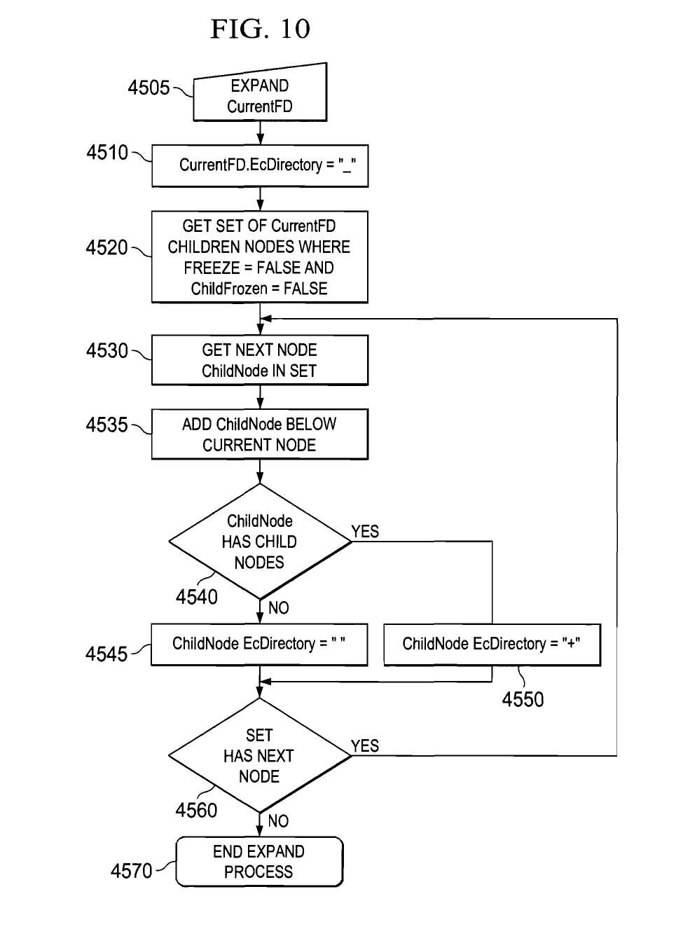

The client (1050) can then send navigation signals, such as expand or collapse, freeze or unfreeze, on some node of interest to the node structure manager (1030). The node structure manager (1030), based on these navigation signals, retrieves then the relevant information from the file system (1010) and updates accordingly the node structure (1020). Reaction from the node structure manager (1030) to freeze and unfreeze navigation signals will be described in greater detail with respect to FIGS. 7 and 8. Reaction from the node structure manager (1030) to expand and collapse signals will be described in further detail with respect to FIGS. 9 and 10.

This implementation is based on a MVC (Model View Controller) abstraction, as it provides a good framework for these kind of problems—interacting with a representation of a set of data. Other implementations are possible, for instance by merging the node structure manager (1030) component and the file system explorer (1040).

The client (1050) can also be an end user or a process that, for instance, needs to navigate the file system in the frame of an installation and would profit from a particular representation of the file system to access some objects more quickly.

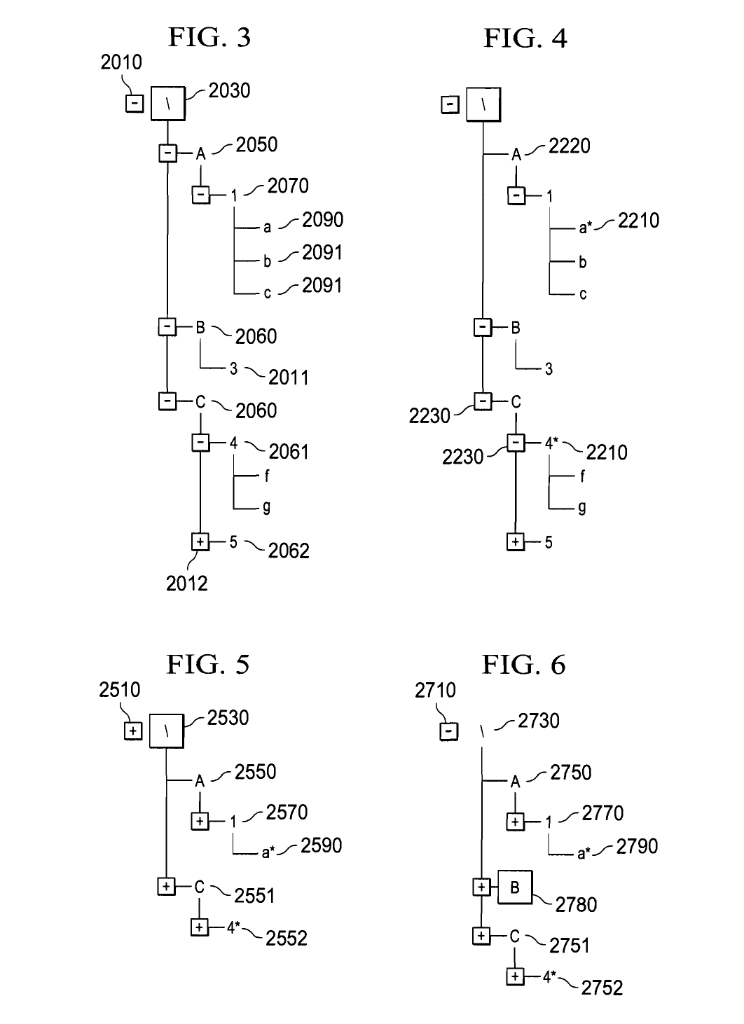

FIG. 2 shows a list of relevant attributes, or characteristics, for a node in an implementation of the present invention. A node, part of the node structure (1020), can contain the following attributes:
a node id (1510), to uniquely identify the node in the file system;
a node name (1511), that would provide a more intellegible way of identifying the node, for instance to an end user;
a parent node id (1520), to identify starting at a given node which node is its parent;
a list of ids of child nodes (1521), to identify which nodes have the current node as parent;
a boolean attribute freeze_indicator (1530), to mark whether a particular node has been designated as frozen by the client (1050);
a boolean attribute child_frozen (1531), to mark whether the current node has one or several child nodes in the node structure (1020) that have the attributes is_frozen (1530) and/or child_frozen (1531) to true; and
a navigation status ec_directory (1540) that can take three values, indicating whether the node is expanded, collapsed, or in a state that can be neither collapsed nor expanded. This state will be described in more details with respect to FIGS. 3, 4, 5, 6.

These values can be set in nodes of the node structure (1020) by the node structure manager (1030). The node name (1511) can be typically retrieved from the file system (1010) and would be the name of the object in the file system corresponding to the node. The node id (1510) can be generated by the node structure manager (1030) when the node is created and added to the node structure (1020).

When a node is added to the node structure (1020) by the node structure manager (1030), the latter also defines its parent id (1520), its children ids (1521) if it has any, its navigation status (1540) to take into account the presence of child nodes, or the values of the attributes child_frozen (1531) or freeze_indicator (1530). The correspondance between the navigation status (1540) of a node and the values of its attributes will be further described with respect to FIGS. 3, 4, 5, 6.

The node value freeze_indicator (1530) is set by the node structure manager (1030) in response to a freeze navigation signal sent by the client (1050). The node structure manager (1030) can also update the file system (1010) to store permanently the freeze_indicator (1530) value. Thus, the value can also be set when the node is added to the node structure (1020), by retrieving the value from the file system (1010).

The node value child_frozen (1531) is set by the node structure manager (1030) in response to a freeze navigation signal sent by the client (1050). The node structure manager then updates all the parent nodes of the node on which the freeze event occurred. It can also update the file system (1010) itself to store the alteration permanently. In this case, the value of child_frozen (1531) can be loaded from the file system (1010) when the node structure manager (1030) builds its representation (1020).

Conversely, these attributes are updated when an unfreeze event is send to the node structure manager (1030). This will be described in more details with respect to FIGS. 7 and 8.

An alternative which would provide sub optimal performance would be to omit the child_frozen attribute (1531) and compute its value on the fly based on the value of freeze_indicator (1530).

It is also possible to use the path of a node to identify it uniquely. The node id, parent id and child ids could be thus omitted.

It is also possible to derive on the fly the child nodes of a particular node by analyzing the parent id of all nodes.

The attribute child node id (1521) can thus be omitted.

FIG. 3 shows a graphical presentation of a node structure (1020), comprising:
a root node (2030);
a set of first level child nodes (2050, 2060);
further nodes (2070, 2090, 2091, 2061, 2062) that are below the first level nodes. Nodes (2070), (2090) and (2091) are said to be hierarchilly inferior to node (2050), while node (2070) is said to be a first level, or first generation, child node of node (2050). Conversely, nodes (2030) and (2050) and parents of node (2070), but node (2050) is a direct parent node of node (2070).

The node structure would be the output of the node structure manager (1030). Such output would comprise a set of nodes along with their attributes as described with respect to FIG. 2.

In the node structure as presented in FIG. 3, the root node (2030) would have itself as the parent_id (1520), ‘\’ or ‘/’ as name (1511), nodes ‘A’, ‘B’ and ‘C’ (2050, 2060) as child nodes (1521), false as value for the freeze_indicator (1530), false being the default value, false for child_frozen (1531), and ec_dicrectory would have the value ‘−’ (2010). The same can then be derived for the other nodes, with node ‘5’ (2062) having ‘+’ (2012) for ec_directory and node ‘3’ having ‘ ’ (2011) for ec_directory.

In the rest of the description, we would refer indifferently to the node structure or its graphical presentation as the graphical presentation is merely a graphical interpretation of the node structure and there is a simple correspondence between the two. It should be kept in mind that the node structure is itself a representation of the file system (1010).

Such node structure could be presented as such by the file system explorer (1040) or this component could perform further processing.

A node represents an object in the file system. Each object can be either a file or a folder. A file, such as file a, b or c (2090, 2091), is a particular object that can't have any children. Thus a node representing a file can't have any child node.

A node has one parent node and can have zero, one or several child nodes. It is therefore possible to associate each node with a particular path, that will be the equivalent of an object path in the file system.

Thus a node can have several parent nodes at different levels in the hierarchy. It can also have child nodes below the first level of child nodes.

A node can be selected, such as node (2030) as shown in FIG. 3. A process, such as the node structure manager (1030), can then access the node attributes, such as id (1510) of a node, its parent node id (1520), its child nodes ids (1521), etc, and perform operations on the node, such as set its freeze_indicator (1530) or navigation status (1540).

A node is associated with a navigation status. The node can be collapsed (2012), this is represented with a ‘plus’ sign; it can be expanded (2010), this is represented with a ‘minus’ sign; or it can't be expanded, for instance because it doesn't have any child node or because all its child nodes have freeze_indicator equals true or child_frozen equals true, this is represented with a blank sign ‘ ’ (2011). Thus if a node has a navigation status ‘plus’ or ‘minus’, it means this node has child nodes.

The node structure as presented in FIG. 3 thus provides a set of nodes that are directly accessible when traversing the file system. The nodes that are under the node (2062) located at the path ‘\C\5’ are not yet accessible. Node (2062) must first be expanded, then the list of available child nodes is represented in the node structure, and eventually these child nodes are accessible.

Different presentations of the same node structure are possible. The one presented here is only for illustration purposes. For instance, full path can be presented for each node, instead of only the node name.

FIG. 4 shows a node structure in which two nodes (2210) have been frozen in an implementation of the present invention.

The node structure (1020) has been updated by the node structure manager (1030) in reaction to a freeze signal that has been sent by the client (1050) on each of the two designated nodes (2210).

As a consequence, the freeze indicators (1530) of the nodes (2210) have been set to true. The parent nodes child_frozen attributes (1531) up to the root node (2030) have been set to true. The navigation status (1540) of all the updated nodes have also been updated. Thus node ‘A’ ec_directory (2220) has been set to ‘ ’ because all the child nodes (node ‘1’ (2070)) of ‘A’ (2050) have the child_frozen attribute (1531) set to true. But nodes ‘C’ and ‘4’ ec_directory attributes (2230) are ‘−’ because these nodes still have a child node that has child_frozen (1531) to false (node ‘5’ (2062)).

The consequences of a freeze or unfreeze action will be described in detail with respect to FIGS. 7 and 8.

FIG. 5 shows a collapsed node structure in an implementation of the present invention. The node structure (1020) as presented in FIG. 4 has been updated by the node structure manager (1030) in response to a collapse signal sent on root node (2030). The result node structure is shown in FIG. 5.

Root node (2530) has its navigation status (1540) set to ‘+’, because it is collapsed and have child nodes that have child_frozen (1531) set to false.

Some nodes (2550, 2570, 2590, 2551, 2552) below the collapsed node (2530) are still represented in the node structure. The nodes (2590) and (2552) have been set as frozen as described with respect to FIG. 4. As a consequence, their parent nodes child_frozen attribute (1531) have been set to true. The file system representation as shown in FIG. 5 is a consequence of this action. It provides a direct access to the frozen nodes while maintaining the underlying file system organization.

The frozen node and its parents can be presented in different manners by the file system explorer (1040). In FIG. 5 they are shown like a traditional files and folders.

Alternatively, a more condensed form could be shown by displaying only the frozen node on a line.

FIG. 6 shows a node structure with some nodes collapsed and a node expanded, in an implementation of the present invention. As shown in this figure, the node structure (1020) has been updated in response to an expand signal that occurred on root node (2530).

The node structure as described with respect to FIG. 5 has been updated. The navigation status (2710) of the root node is now ‘−’. And the child node ‘B’ (2780) has been added to the node structure. The rest of the nodes, in particular the nodes with attributes child_frozen (1531) or freeze_indicator (1530) set to true are still visible.

FIG. 7 shows a method for altering, or compiling, the node structure when a freeze event is detected (3010), in an implementation of the present invention. The event is generated in response to an action of the client (1050) that designates a particular node of the node structure (1020).

The node structure manager (1030) updates the node structure (1020) in response to the freeze event (3010). It first gets a handle for the node on which the freeze event occurred and set the freeze_indicator (1530) attributed of the designated node to true (3020).

Then the node structure manager (1030) gets a handle for the parent node (1520) of the current node (3025), which become the current node. It sets its child_frozen attribute (1531) to true (3040).

Then the node structure manager (1030) estimates whether all the child nodes (1521) of the current node have their freeze_indicator (1530) or child_frozen (1531) attributes to true (3045). In the case of a positive outcome, the ec_directory attribute (1540) of the current node is set to ‘ ’ (3050), because the node can't be collapsed; in the case of a negative outcome, the ec_directory attribute (1540) of the current node is set to ‘−’ (3080), because the node was necessarily expanded for a freeze event to happen on one of its child nodes.

In the next step, if the current node is the root node (3090), then no further iteration can be made and the process is ended (3095), otherwise, the process loops back to step (3025) to get the next parent node.

FIG. 8 shows a method for compiling the node structure (1020) when an unfreeze event is detected (3510), in an implementation of the present invention. The event is generated in response to an action of the client (1050) that designates a particular node of the node structure (1020).

The node structure manager (1030) updates the node structure (1020) in response to the unfreeze event (3510). It first get a handle for the node on which the unfreeze event occurred and set this node's freeze_indicator (1530) to false (3520).

Then the node structure manager (1030) tests whether the current node has at least one of its child nodes (1521) with their freeze_indicator (1530) or child_frozen (1531) attributes to true (3530). In the case of a positive outcome, then nothing needs to be updated further, the method is ended (3595). In the case of a negative outcome, the node child_frozen attribute (1531) is set to false (3570).

After step (3570), a test is performed whether the direct parent of the current node is collapsed (3575). If it is, then the node and all its child nodes are removed from the node structure (3580); if not, then nothing needs to be done and the method can stop (3595).

The node structure manager (1030) can determine if a node is collapsed by comparing its list of child nodes (1521) and the child nodes defined at the file system level. If they are the same, the node is expanded, if not, it is collapsed.

In the next step, the node structure manager (1030) gets a handle for the parent node (1520) of the current node (3592), which become the current node, and the method loops back to step (3530).

FIG. 9 shows a method for compiling the node structure (1020) when a collapse event (4005) on a node is detected, in an implementation of the present invention. The purpose of this method is to incorporate, or include, a set nodes that will be in the node structure (1020) below the collapsed node. The node structure manager will then update the current node representation with the result tree.

In an implementation of the preferred embodiment, the result is represented in the form of a tree (4010). Then the node on which the collapse event occurred is added to the result tree (4015). In a normal file system representation, no further nodes would be added to the tree. According to the present invention, the node structure manager (1030) will add the frozen nodes to improve navigability of the file system.

In step (4020), the node structure manager (1030) gets, based on current node's child_node_ids (1521), the set of child nodes that have child_frozen (1531) or freeze_indicator (1530) attributes set to true.

If the set is empty (4025), then the node has no child node to display, the node navigation status (1540) will then be determined (4070). If the node has no child node (this should only occur on a node with freeze_indicator (1530) set to true), then ec_directory (1540) is set to ‘ ’ (4075). If the node has some child node, then ec_directory (1540) is set to ‘+’ (4080). The result tree is then returned (4090).

If the set is not empty (4025), the node structure manager (1030) will then loop to apply recursively the current method to the child nodes in the set. All the other child nodes don't need to be added to the node structure (1020). Thus, the node structure manager (1030) first gets the next child node in the set (4030), executes method described with respect to FIG. 9 and adds the resulting tree to the current result tree (4035), and loops to step (4030) if there is still some child node in the set to process (4040). If not, the node structure manager (1030) estimates the navigation status (1540) of the current node (4045). If all the child nodes (1521) of the current node have the attributes child_frozen (1531) or freeze_indicator (1530) to true, then ec_directory (1540) is set to ‘ ’ (4050). Otherwise, ec_directory (1540) is set to ‘+’ (4055). Alternatively, the ec_directory (1540) can always be set to as the node is collapsed. Finally, the result tree is returned (4090).

When the file system (1010) is first analyzed by the node structure manager (1030), the latter first builds the node structure (1020) as if a collapse event occurred on the root node. Thus all the frozen nodes and their parents are in the initial file system representation.

FIG. 10 shows a method for compiling the node structure (1020) when an expand event on a node is detected (4505), in an implementation of the present invention. The expand action that triggers the expand event is not available for nodes of which all child nodes are frozen or have a child_frozen attribute (1531) to true. In addition, since the node structure already contains the frozen nodes and their parents, the expand method doesn't take them into account.

Thus just after the expand event is detected, the current node ec_directory (1540) is set to ‘−’ (4510). Then the node structure manager (1030) gets from the file system (1010) the set of child objects where freeze_indicator (1530) is false and child_frozen (1531) is false (4520).

Then for each child node in this set (4530), the node structure manager (1030) adds it below the current node in the node structure (1020) (4535). Then a test is performed (4540) whether the current child node has any children object on the file system (1010). If it has, then the child node ec_directory attribute (1540) is set to ‘+’ (4550), if not, it is set to ‘ ’ (4545). The method then loops to step (4530) to process next child node if it exists (4560). If there isn't any other node, the method ends (4570).

Another embodiment comprises a file system representation (1020), comprising a set of nodes, each node comprising attributes to indicate whether it is a frozen node or whether there is a frozen node below it, said file system representation being adapted to provide direct access to frozen nodes.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1-10. (canceled)

11. A method of representing file system objects using respective nodes in a hierarchical structure, wherein said file system objects are each associated with a first characteristic set to one of a first and a second value, said method comprising a step of compiling said hierarchical structure to represent objects hierarchically inferior to a first object by incorporating in said hierarchical structure only nodes representing: (1) in response to a first navigation signal, all children objects which are children of said first object and whose first characteristic has said second value, and all parent objects which are parents of an object associated with said second value; and (2) in response to a second navigation signal, all objects which are one of (i) first generation children of said first object, (ii) children of said first generation children whose first characteristic has said second value, and (iii) children of said first generation children who are parents of an object associated with said second value.

12. The method of claim 11 comprising the further steps of:
designating one of said file system objects; and
setting, in response to said designation, the first characteristic associated with said designated object to said second value.

13. The method of claim 12 wherein said first characteristic is permanently stored.

14. The method of claim 12 wherein said file system objects are each associated with a second characteristic set to one of a third and a fourth value, said method comprising the further steps of:
identifying, in response to said designation, objects which are parents of said second object; and
setting the second characteristic associated with each object so identified to said fourth value, in response to said designation.

15. The method of claim 14 wherein said second characteristic is permanently stored.

16. The method of claim 11 further comprising the steps of:
receiving a further one of said navigation signals on a chosen object, wherein said chosen object is one of said objects associated with said second value; and
repeating, in response to said further navigation signal, the compiling step of claim 1, with said chosen object replacing said first object.

17. The method of claim 11 wherein said first navigation signal is a collapse signal.

18. The method of claim 11 wherein said second navigation signal is an expand signal.

19. A computer readable medium comprising instructions for carrying out each step of the method according to claim 11.

20. An apparatus comprising means adapted for carrying out each step of the method according to claim 12.

21. A system for representing file system objects using respective nodes in a hierarchical structure, wherein said file system objects are each associated with a first characteristic set to one of a first and a second value, said system comprising:
means for compiling said hierarchical structure to represent objects hierarchically inferior to a first object by incorporating in said hierarchical structure only nodes representing: (1) in response to a first navigation signal, all children objects which are children of said first object and whose first characteristic has said second value, and all parent objects which are parents of an object associated with said second value; and (2) in response to a second navigation signal, all objects which are one of (i) first generation children of said first object, (ii) children of said first generation children whose first characteristic has said second value, and (iii) children of said first generation children who are parents of an object associated with said second value; and
means for displaying said hierarchical structure on a display device.
